(19) United States
(12) Patent Application Publication
(10) Pub. No.: US 2012/0127514 A1
(43) Pub. Date: May 24, 2012

(54) PROCESSING REUSABLE AND SPECIFIC CONTENT

(76) Inventors: Lev Gloukhenki, Kfar Saba (IL); Dmitry Smimov, Ramat Gan (IL); Michael Burenkov, Ramat Gan (IL); Leonid Khain, Herzliya (IL)

(21) Appl. No.: 12/952,263

(22) Filed: Nov. 23, 2010

(51) Int. Cl. G06F 3/12

(52) U.S. Cl. 358/1.15

(57) ABSTRACT

An apparatus adapted to process VDP print job for digital printing includes a plurality of processing elements wherein each of the processing elements is adapted to receive a chunk of the VDP print job for processing. A coordination element is adapted to coordinate between the processing elements to first process all reusable elements in the VDP print job during a first stage before starting processing of specific content in the assigned chunk during a second stage. A cache storage element is adapted to store the processed reusable elements during the first stage.

### CROSS REFERENCE TO RELATED APPLICATIONS

Reference is made to commonly-assigned copending U.S. patent application Ser. No. ______ (Attorney Docket No. 96706/NAB), filed herewith, entitled PROCESSING REUSABLE AND SPECIFIC CONTENT, by Gloukhenki et al.; and U.S. patent application Ser. No. 11/858,477, filed Sep. 20, 2007, now U.S. Publication No. 2009/0080025, entitled PARALLEL PROCESSING OF PAGE DESCRIPTION LANGUAGE, by Aronshtam et al.; the disclosures of which are incorporated herein.

### FIELD OF THE INVENTION

The present invention relates to efficient processing of page description language (PDL) objects among processing elements in a digital front end system and more specifically to the field of variable data printing (VDP).

### BACKGROUND OF THE INVENTION

Digital frontends or color print servers are designed to process data for digital printers. A digital frontend will usually receive a job to be printed in the form of a page description language (PDL) for processing.

The PDL job 204, shown in FIG. 2, can be represented, for example, in a page definition file (PDF), Postscript (PS), personalized print markup language (PPML), or variable PostScript (VPS). The frontend will process PDL job 204 and prepare it for printing. The printing speed of digital printers is growing rapidly. For example, the speed of Kodak Minerva printers exceeds 2,000 A4 size impressions per minute. Such printing speeds impose challenges on the digital servers that should process PDL jobs 204 and drive these high speed printers.

Since every printed impression on a digital printer can contain different data, variable data printing (VDP) jobs are often used in conjunction with digital printers. Data contained in VDP files can be divided into two categories: reusable and non-reusable content (objects). FIG. 1 shows schematically a structure of two pages page 1 (104) and page 2 (108), from a typical VDP PDL job 204. Reusable objects (120, 124) appear on more than one page (104, 108), while non-reusable (or in-line) objects represent specific content 112 and 116 for pages 104 and 108 respectively. Each of the two types or data, reusable or specific content, may represent text, graphics or images.

An efficient method of VDP data handling is processing (rasterizing) of reusable objects (120, 124) only once, caching processing results and reusing it for composition of pages that include these reusable objects. Further improvement of VDP processing performance is possible by involving multiple processing elements (PE). Those PEs can be multiple processing jobs, multiple processor residing in a single server, multiple servers connected within a single network, or a combination of them. The PDL job 204 is split into plurality of PDL chunks. Each PDL chunk e.g. 208, 212, and 216 is fed to individual PEs 220, 224, and 228 respectively. In such an environment multiple processing engines shall share common cache (not shown) for processed reusable objects.

Traditionally PDL processing is done in a sequential manner from a first page in a PDL job 204 or in a PDL chunk such as 208. Chunks are used, as described above, in the case where a PDL job 204 is if split between several PEs (such as 220). In this case each of the PEs builds an entire layout for each page.

For example, in FIG. 2, PE 220 encounters a reusable object 232 in the content of page 2 of PDL chunk 208, and derives its geometric (shape, size) and other properties of the element. As mentioned above each reusable element should be produced only once, at this first encounter. Therefore, before starting processing, the processing element requests shared cache. On cache hit (an element was already processed and needed information is ready and available) PE 220 will use the information on reusable object 232 for building of page layout, and will skip element processing. On cache miss, it will process the element itself, use the information and then will add the element to the cache for benefit of further processing. Assume that cache query time is insignificant compared to object processing time. Then assume that in this example PE 220 encounters cache miss (element is not in cache) and therefore it starts processing reusable object 232.

This algorithm is simple and straight forward for implementation; however, it has certain cavity which can lead to forced unwanted synchronization of multiple processing engines. PEs 224 and 228 process PDL chunks 212 and 216 respectively. Each of the PEs 224 and 228 encounters a reusable object 232 in the second page of each of the PDL chunks (212, 216) processed by them. A cache inquiry is made by each of the PDL chunks (212, 216) yielding a result that reusable object 232 is in middle of processing by PDL chunks 208. This result in unfavorable in respect to system performance, since it will impose an idle state on both PDL chunks 212 and 216, causing them to wait until reusable object 232 processing is fully completed by PDL chunks 208.

FIG. 3 illustrates the problem. Time line is represented by numeral 300. At a given time moment T0 PE 220 encounters reusable object 232, it will take time T1 to process it. If during time interval from T0 to T1 any other processing engine (224, 228) will request information about the same element it will be notified that element is being processed by PE 220 and will have to wait until processing is completed and information about reusable object becomes available.

FIG. 3 shows that during processing 304 of reusable object 232 by PE 220, PEs 224 and 228 are idle state 308 and 312 respectively. PEs 224 and 228 will commence processing (320, 324) of the remainder of PDL chunks 212 and 216 respectively during time slots, immediately after PE 220 competes processing of reusable object 232. PE 220 will then complete processing (316) of the remainder of PDL chunk 208. Thus, in an extreme case, all but one processing engines can come to a wait state, which will result in significant performance degradation.

### SUMMARY OF THE INVENTION

Briefly, according to one aspect of the present invention an apparatus adapted to process VDP print job for digital printing includes a plurality of processing elements wherein each of the processing elements is adapted to receive a chunk of the VDP print job for processing. A coordination element is adapted to coordinate between the processing elements to first process all reusable elements in the VDP print job during a first stage before starting processing of specific content in the assigned chunk during a second stage. A cache storage element is adapted to store the processed reusable elements during the first stage.

These and other objects, features, and advantages of the present invention will become apparent to those skilled in the art upon a reading of the following detailed description when taken in conjunction with the drawings wherein there is shown and described an illustrative embodiment of the invention.

### BRIEF DESCRIPTION OF THE DRAWINGS

The subject matter regarded as the invention will become more clearly understood in light of the ensuing description of embodiments herein, given by way of example and for purposes of illustrative discussion of the present invention only, with reference to the accompanying drawings (Figures, or simply “Figure”), wherein:

FIG. 1 is a schematic illustrating pages from a PDL job containing reusable and specific content;

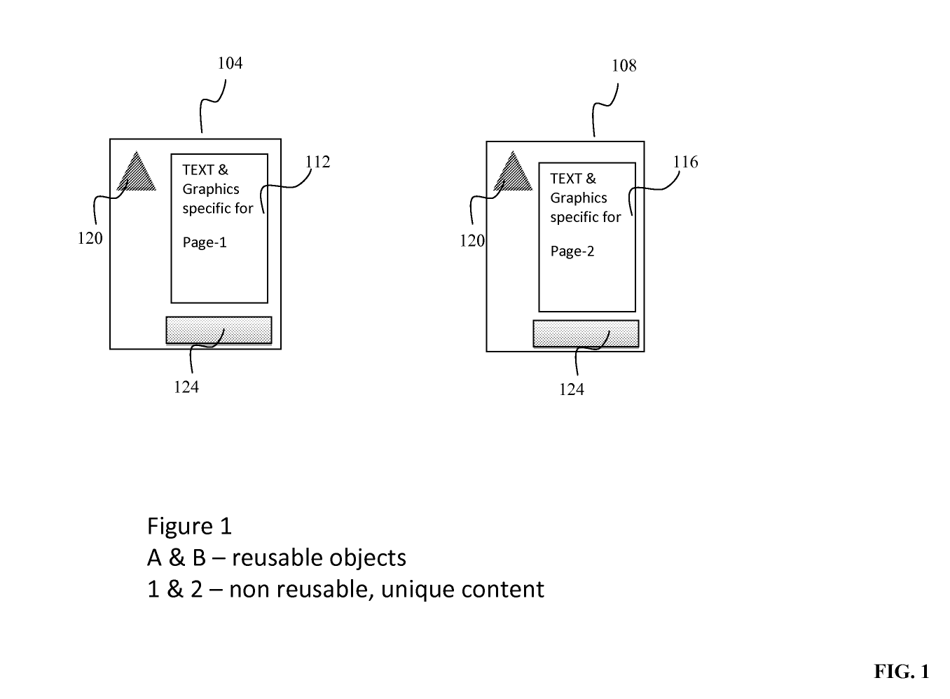

FIG. 2 is a schematic illustrating a PDL job split into chunks, each chunk is distributed to a distinct processing element;

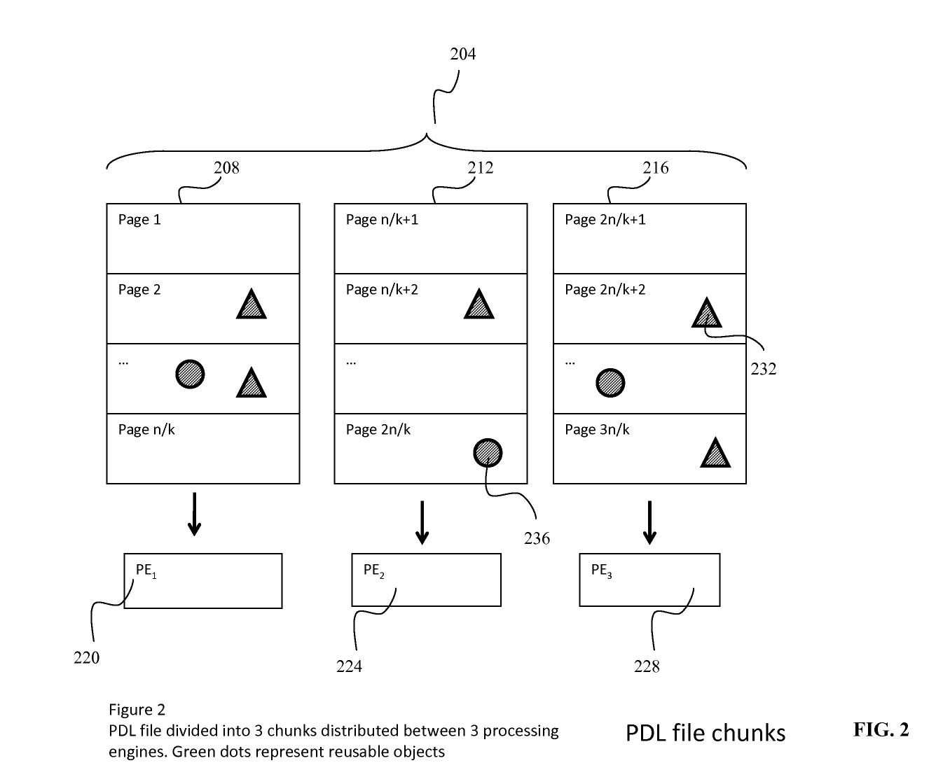

FIG. 3 is a schematic illustrating of a time diagram showing an idle state created when processing a reusable element; and

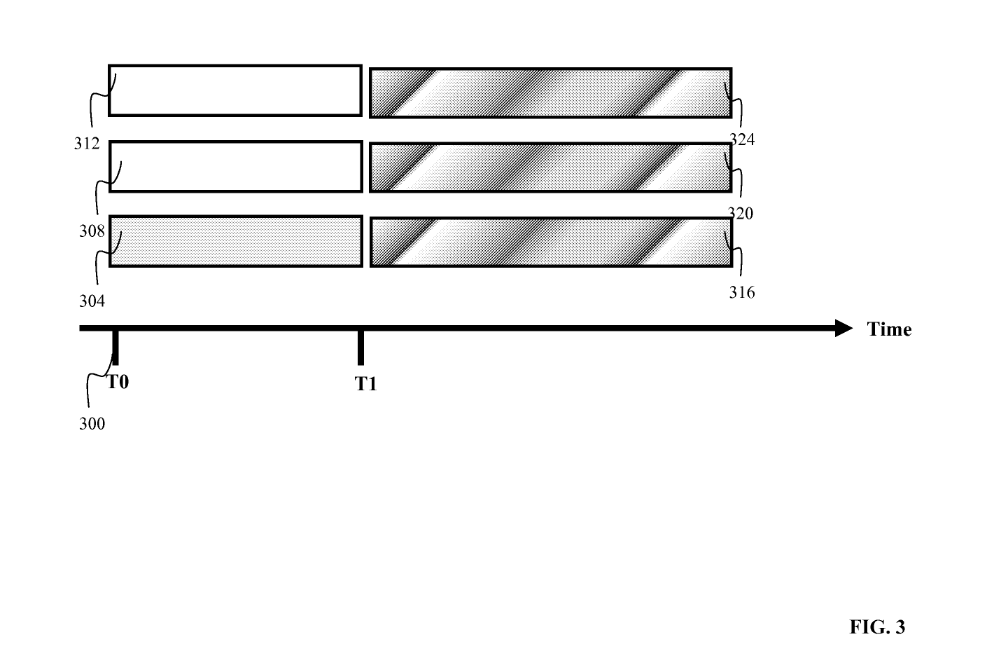

FIG. 4 is a schematic illustrating of a time diagram showing a two phase processing scheme, first the reusable elements are processed followed by processing of chunk specific data content.

### DETAILED DESCRIPTION OF THE INVENTION

In the following detailed description, numerous specific details are set forth in order to provide a thorough understanding of the disclosure. However, it will be understood by those skilled in the art that the teachings of the present disclosure may be practiced without these specific details. In other instances, well-known methods, procedures, components and circuits have not been described in detail so as not to obscure the teachings of the present disclosure.

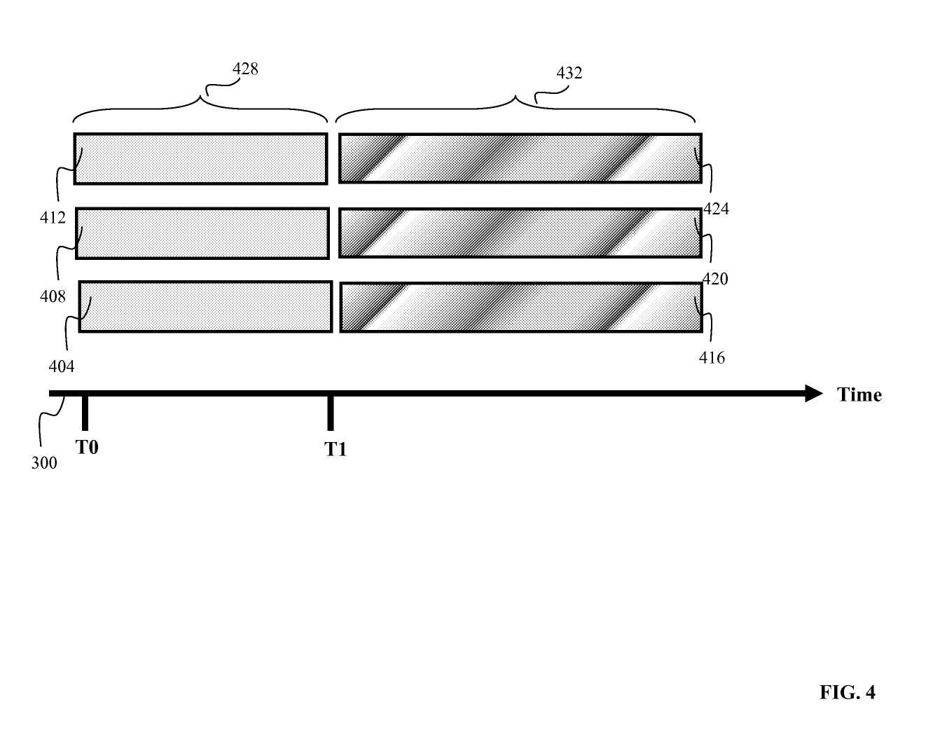

FIG. 4 shows a time diagram that illustrates a proposed solution of the problem described above in the background section. The present invention splits the PDL job 204 processing into two phases, to be performed by each of the PEs substantially in parallel.

During the first phase 428 all the processing elements 220, 224 and 228 will process just reusable objects such as 232 and 236, while skipping all non-reusable content (such as 112, 116). During phase 432, PEs 220, 224, and 228 will each process the reusable object of PDL job 204, during time slots 404, 408 and 412 respectively. In the case that during first phase 428 PE 224, for example, will encounter a reusable object 232 which is being processed by PE 220 it should not wait for the completion of the processing of reusable object 232, but will switch to the next reusable object, for example 236, and will process it unless it had not been processed yet. Alternatively, in the case there are no reusable objects to be processed for PE 224, it will complete first phase 428 processing of the PDL chunk assigned to it, in the example of PE 224 it will be chunk 212.

At the stage that a certain PE completed its first phase 428 assignments it will continue to second stage 432, alternatively all PEs can be synchronized, so all will start stage 432 at the same time, however this method might be less efficient. The synchronization between the processing elements between stages 428 and 432 are performed by a coordination element (not shown).

During the second phase 432 PEs 220, 224, and 228 will process just the non-reusable content, such as 112 and 116, during respective processing time slots 416, 420, and 424. Since all reusable objects were processed by time Ti during first phase 428, any cache query to the shared cache storage (not shown) will be guaranteed as a cache hit. Implementation of this solution will avoid inefficiencies described in the background section, and will eliminate any unwanted waiting periods for the processing elements and thus will increase effectiveness and performance of VDP based jobs.

The invention has been described in detail with particular reference to certain preferred embodiments thereof, but it will be understood that variations and modifications can be effected within the scope of the invention.

### PARTS LIST

104 page 1
108 page 2
112 page 1 specific data
116 page 2 specific data
120 reusable object 1
124 reusable object 2
204 PDL job
208 PDL chunk (of 204) provided to processing element 220
212 PDL chunk (of 204) provided to processing element 224
216 PDL chunk (of 204) provided to processing element 228
220 processing element (PE)
224 processing element (PE)
228 processing element (PE)
232 reusable object 1
236 reusable object 2
300 time line
304 PE 220 processes reusable element 1
308 PE 224 in idle waiting for PE 220 to process reusable element 1
312 PE 228 in idle waiting for PE 220 to process reusable element 1
316 PE 220 processes continues to process remainder PDL chunk 208
320 PE 224 processes continues to process remainder PDL chunk 212
324 PE 228 processes continues to process remainder PDL chunk 216
404 PE 220 processes reusable elements of job 204
408 PE 224 processes reusable elements of job 204
412 PE 228 processes reusable elements of job 204
416 PE 220 processes specific elements to PDL chunk 208
420 PE 224 processes specific elements to PDL chunk 212
424 PE 228 processes specific elements to PDL chunk 216
428 Phase I—processing of reusable elements
432 Phase II—processing of specific elements processing

1. An apparatus adapted to process VDP print job for digital printing comprising:
plurality of processing elements wherein each of the processing elements is adapted to receive a chunk of the VDP print job for processing;
a coordination element adapted to coordinate between the processing elements to first process all reusable elements in the VDP print job during a first stage before starting processing of specific content in the assigned chunk during a second stage; and
a cache storage element adapted to store the processed reusable elements during the first stage.

2. The apparatus according to claim 1 wherein the processing elements comprise a plurality of central processing units residing in a single server, a plurality of computer servers connected in within a single network or a combination thereof.

3. The apparatus of claim 1 wherein the print description language is Postscript, Variable Postscript, PPML, PDF, or a combination thereof.

4. The apparatus of claim 1 wherein the second phase will start independently by each of the processing elements after completion of the first phase processing.

5. The apparatus of claim 1 wherein the second phase will start after all the processing elements complete the first phase.
